(19) United States
(12) Patent Application Publication
(10) Pub. No.: US 2009/0087310 A1
(43) Pub. Date: Apr. 2, 2009

(54) Device for Transducing of Power

(76) Inventor: Jordan Knez, Halmstad (SE)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/922,721

(22) PCT Filed: Jun. 15, 2006
(86) PCT No.: PCT/SE2006/000724

§ 371 Date: Apr. 3, 2008

(30) Foreign Application Priority Data
Jun. 22, 2005 (SE) 0501461-8

(51) Int. Cl. F03D 11/00; F03D 1/04

(52) U.S. Cl. 415/208.2; 416/179

(57) ABSTRACT

The present invention relates to a device for transducing and/or converting of wind power into another power, for example electric power, comprising a rotor which is rotary in a tunnel tube which is mounted on the upper end of a tower the rotor having an outer ring, an inner ring and a number of blades or vanes, which extend between the rings, the outer ring having a depression extending between the edges for a belt or the like which extends to a shaft on the underside of the tunnel tube for rotation thereof on rotation of the rotor.

The present invention relates to a device according to the preamble to appended claim 1.

Wind power is being extracted to steadily growing extent and is becoming more attractive as a renewable source of energy. In recent years, the trend has pointed more and more in a direction towards ever larger and ever taller wind power stations, with attendant severe problems with great forces and extremely high weights, as well as the consequential constructional and mechanical strength problems. The increasingly larger and taller wind power stations have also resulted in serious noise problems, and vigorous protests have been voiced above all from neighbouring residents. There is thus a considerable need in the art for a total efficiency improvement in wind power stations for a better energy yield, above all from smaller and lower wind power stations.

The task forming the basis of the present invention is to satisfy the above-mentioned needs in a device of the type described by way of introduction.

This task is solved according to the present invention in the device disclosed by way of introduction in that a device has been given the characterising features as set forth in appended claim 1.

The present invention makes for the construction of wind power stations with a considerably higher energy yield per rotor surface than has hitherto been possible. Prior art wind power stations very seldom exceed 0.2-0.3 kW/m² rotor surface in highly favourable wind conditions. In addition, the present invention makes for a considerably simpler and more cost-effective construction than in the prior art wind power stations. The expected energy yield is calculated at more than 0.5 kW/m² per rotor surface, which in many cases may entail twice as much as in prior art wind power stations.

One embodiment of a device according to the present invention will now be described in greater detail hereinbelow, with reference to the accompanying drawings.

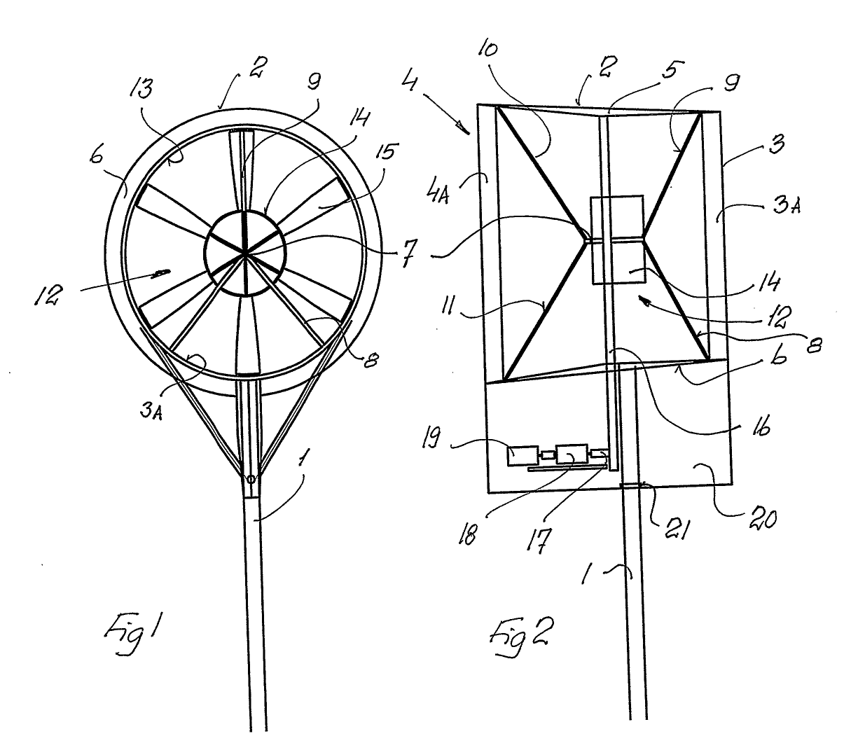

FIG. 1 is a schematic view of one embodiment of a device according to the present invention.

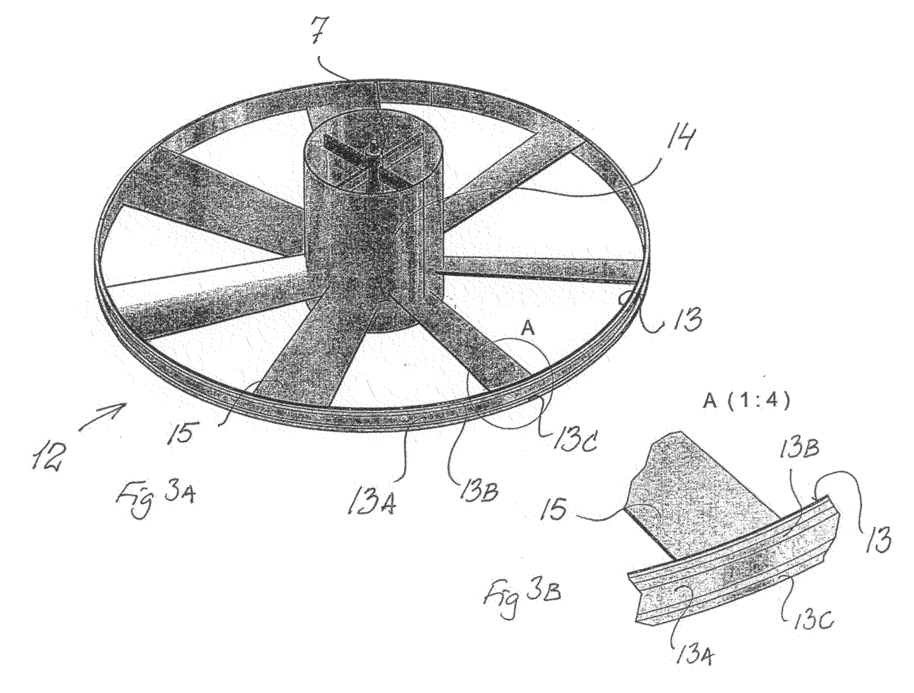

FIG. 2 shows a schematic section through the view illustrated in FIG. 1.

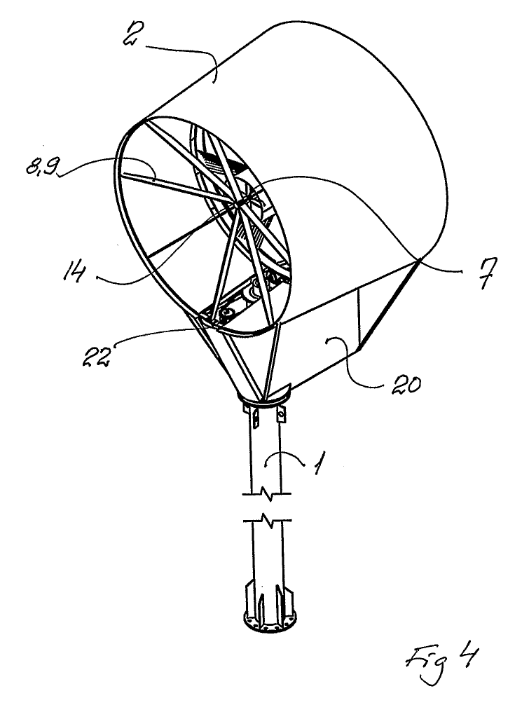

FIG. 3A is a photographic representation of a rotor for a device according to the present invention.

FIG. 3B shows, on a larger scale, a part of the rotor in FIG. 3A.

FIG. 4 shows a three-dimensional view of another embodiment of the device according to the present invention.

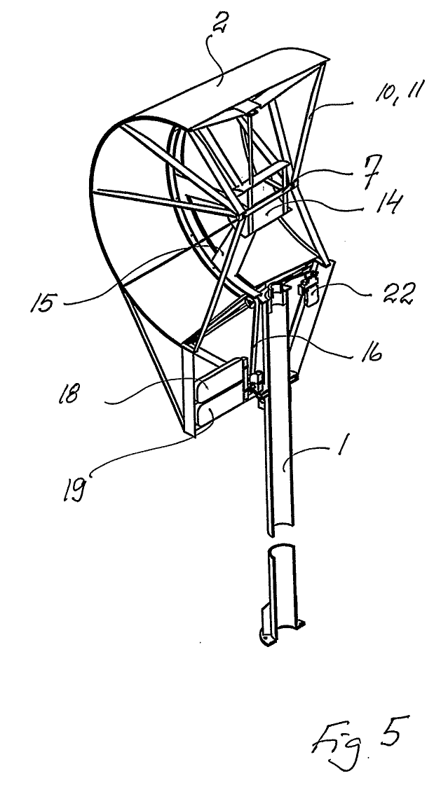

FIG. 5 shows a three-dimensional view of the embodiment according to FIG. 4 in the opposite direction, parts having been removed for purposes of clarity.

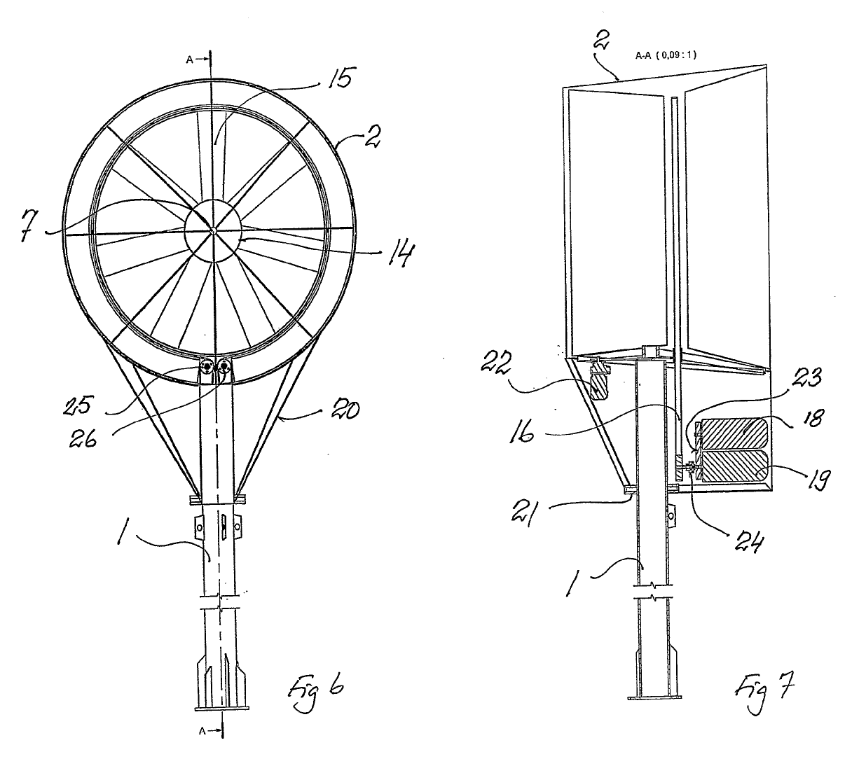

FIG. 6 is a view of the embodiment in FIGS. 4 and 5.

FIG. 7 is a section taken in the direction of the arrows A-A in FIG. 6.

The version of a device according to the present invention illustrated in FIGS. 1 and 2 is mounted on a tower 1. The tower 1 is in the form of a tube of optional height. At the top, the tube 1 is provided with suitable bearings for revolving mounting of a tunnel tube 2. The tunnel tube 2 has an inlet opening 3 and an outlet opening 4. As is most clearly apparent from FIG. 2, the inlet opening 3 is slightly smaller than the outlet opening 4. The inlet opening 3 is formed from a ring 3A and the outlet opening is formed from a ring 4A. The rings 3A and 4A are connected to one another by means of rods 5 and a casing or cowl 6 which is laid outside the rods 5 and the rings 3A and 4A.

The tunnel tube 2 is held in position on a shaft 7 by means of struts 8, 9, 10 and 11 which extend from the rings 3A, 4A to the shaft 7. Advantageously, the struts 8 and 9 are welded together to the ring 3A, while the struts 10 and 11 are secured on the ring 4A and the shaft 7 by means of bolts with a view to permitting simple mounting and dismounting of a rotor 12 which is rotatably journalled on the shaft 7 between the ends of the struts 8 to 11 most proximal the shaft 7.

The rotor 12 has an outer ring 13 and an inner ring 14. As is most clearly apparent from FIG. 2, the outer ring 13 is narrower than the inner ring 14. Between the rings 13 and 14, there are disposed impeller blades or vanes 15 uniformly distributed around the rings. The blades or vanes 15 are suitably bent in concave configuration in a direction towards the inlet opening 3. The configuration or profile of the blades or vanes 15 is naturally completely optional, with a view to extracting as much energy as possible from the wind passing through the tunnel tube 2. It is also conceivable to provide adjustable blades or vanes 15. The longer portion of the inner ring 14 will guide the wind towards the blades or vanes 15. The trailing edge of the blades or vanes 15 may also be formed in an optimum manner from the aerodynamic point of view.

The outer ring 13 of the rotor 12 has a depression in the intermediate section of the ring 13. A belt 16 is impressed between the edges and extends around the major portion of the ring 13 down under the tunnel tube 2 to a shaft 17 which is connected to the generators 18 and 19 in the present embodiment 2. The parts beneath the tunnel tube 2 may be covered by means of a screen 20 which consists of two plates connected to one another at the front edge below the ring 3A and extending past the tube 1 in order to have the parts 17, 18 and 19 between them. Between the screen plates 20, there is further disposed a motor 22 illustrated in FIGS. 4 to 7 for revolving the tunnel tube 2 by the intermediary of a suitable transmission, for example a sprocket wheel and possibly a drive chain which may be disposed at the under edge of the tunnel tube 2.

The screen plates 20 may, at the lower edge, be provided with a support bearing 21. The support bearing 21 may possibly be combined with a sprocket wheel and a motor for revolving the tunnel tube 2. It is also possible to revolve the entire tube 1 by means of a device placed at its foot.

FIGS. 4 to 7 show in greater detail an additional embodiment of the device according to the present invention, which differs from the embodiment illustrated in FIGS. 1 to 3B substantially only in design details. For example, the generators 18 and 19 are mounted above one another and are interconnected by means of a belt 23 which, by the intermediary of a transmission 24, is driven via the belt 16 which extends via a pair of bending rollers 25 and 26 to and around the ring 13.

Many modifications are naturally possible without departing from the scope of the inventive concept as defined in the appended claims.

1. A device for transducing and/or converting of wind power into another power, comprising: a rotor which is rotary in a tunnel tube which is mounted on the upper end of a tower, wherein the rotor includes an outer ring, an inner ring and a number of blades or vanes, which extend between the rings, and the outer ring includes a depression extending between the edges for a belt which extends to a shaft on the underside of the tunnel tube for rotation thereof on rotation of the rotor.

2. The device as claimed in claim 1, wherein the blades or vanes have a concave surface directed towards the opening of the tunnel tube.

3. The device as claimed in claim 1, wherein the inner ring is longer than the outer ring, and the blades or vanes are secured at the one end on the inner ring while the other end on the inner ring is turned to face towards the opening of the tunnel tube.

4. The device as claimed in claim 1, wherein the shaft on the underside of the tunnel tube is connected to one or more generators.

5. The device as claimed in claim 4, wherein the shaft and the generator(s) are covered by a screen.

6. The device as claimed in claim 1, wherein the tunnel tube includes a leading and a trailing ring, a number of rods extending between the rings, and a cowl extending around the rings and the rods, the rings being supported on a shaft by a number of struts which extend from a central shaft obliquely out to the rings.

7. The device as claimed in claim 1, wherein the rotor with the blades or the vanes is rotatably journalled on the central shaft.

8. The device as claimed in claim 1, wherein the tower (1) comprises a tube.

9. The device as claimed in claim 6, wherein the rotor with the blades or the vanes is rotatably journalled on the central shaft.

10. The device as claimed in claim 2, wherein the tunnel tube includes a leading and a trailing ring, a number of rods extending between the rings, and a cowl extending around the rings and the rods, the rings being supported on a shaft by a number of struts which extend from a central shaft obliquely out to the rings.

11. The device as claimed in claim 3, wherein the tunnel tube includes a leading and a trailing ring, a number of rods extending between the rings, and a cowl extending around the rings and the rods, the rings being supported on a shaft by a number of struts which extend from a central shaft obliquely out to the rings.

12. The device as claimed in claim 4, wherein the tunnel tube includes a leading and a trailing ring, a number of rods extending between the rings, and a cowl extending around the rings and the rods, the rings being supported on a shaft by a number of struts which extend from a central shaft obliquely out to the rings.

13. The device as claimed in claim 5, wherein the tunnel tube includes a leading and a trailing ring, a number of rods extending between the rings, and a cowl extending around the rings and the rods, the rings being supported on a shaft by a number of struts which extend from a central shaft obliquely out to the rings.
